(19) United States
(12) Patent Application Publication
(10) Pub. No.: US 2016/0050906 A1
(43) Pub. Date: Feb. 25, 2016

(54) SMALL GAME CARRIER AND ITS METHOD OF MANUFACTURE

(71) Applicant: Martin Dennis Owen, Callaway, VA (US)

(72) Inventor: Martin Dennis Owen, Callaway, VA (US)

(21) Appl. No.: 14/832,504

(22) Filed: Aug. 21, 2015

Related U.S. Application Data
(60) Provisional application No. 62/040,071, filed on Aug. 21, 2014.

(51) Int. Cl. A01M 31/00; A44B 11/04; A45F 5/00; A44B 11/26

(52) U.S. Cl. CPC A01M 31/006; A44B 11/266; A44B 11/04; A45F 5/00; A45F 2005/006

(57) ABSTRACT

A small game carrier and its method of manufacture are described. The small game carrier may be assembled from two strips of material of unequal length, a male connector, a female connector, two D-rings, and a strap adjuster to create a Bandolier style strap, as well as a ring attached to a bolt snap for securing the ring to the strap and a number of strings for forming nooses that can be secured to the ring to secure small game. The Bandolier style strap comprises two components: a first strap comprising a male connector at one end and a first ring at the other end, and a second strap comprising a female connector at one end and a second ring at the other end. The small game carrier can be assembled by connecting the male connector to the female connector and connecting the bolt snap to the two D-rings.

### CROSS-REFERENCE TO RELATED APPLICATIONS

The present application relies on the disclosure of and claims priority to and the benefit of the filing date of U.S. Provisional Application No. 62/040,071, filed on Aug. 21, 2014, the disclosure of which is hereby incorporated by reference herein in its entirety.

### BACKGROUND OF THE INVENTION

1. Field of the Invention

The present disclosure relates to small game carriers. More particularly, the present disclosure relates to a small game carrier that provides a Bandelier-style strap that attaches to a ring from which nooses for securing small game are held.

2. Description of Related Art

As any hunter knows, having to carry hunting equipment through wilderness areas often leaves the hunter with no hands to carry carcasses of small game such as ducks. Equipment such as duck straps that have been created to solve this problem still require either hand carrying of the strap or else putting an even amount of ducks on each end to balance out so it will sit on your shoulder without falling off. Thus, there remains a need in the art for a solution to this problem.

### SUMMARY OF THE INVENTION

Embodiments of the present disclosure provide a small game carrier and a method of manufacture of a small game carrier. The small game carrier may be assembled from two strips of material of unequal length, a male connector, a female connector, two D-rings, and a strap adjuster to create a Bandolier style strap, as well as a ring attached to a bolt snap for securing the ring to the strap and a number of strings for forming nooses that can be secured to the ring to secure small game. The Bandolier style strap comprises two components: a first strap comprising a male connector at one end and a first ring at the other end, and a second strap comprising a female connector at one end and a second ring at the other end. The small game carrier can be assembled by connecting the male connector to the female connector and connecting the bolt snap to the first ring and the second ring. The strap adjuster makes the Bandolier style strap adjustable in length to accommodate a variety of sizes of hunter. The nooses keep the ducks secured regardless of how they are handled. The small game carrier is simple and easy to use and works the same way no matter how many small game animals need to be secured.

Embodiments of the present disclosure provide a small game carrier, comprising a first strap comprising a male connector at one end and a first ring at the other end, a second strap comprising a female connector at one end and a second ring at the other end and a strap adjuster in between, a third ring with a latch projecting at one end, a plurality of strings tied at the ends to form nooses, wherein the strings are secured to the third ring, wherein the male connector is configured to connect to the female connector, and the latch is configured to connect to the first and second ring.

In embodiments, the second strap may be longer than the first strap and the male connector may be a quick release buckle. Additionally, the first strap and second strap may be adjustable in length. The male connector may be connected to the female connector and the bolt snap may be connected to the first and second ring. In embodiments, the first ring and second ring may be D-rings.

Embodiments of the present disclosure provide a method of manufacture of a small game carrier comprising providing a first strap comprising a male connector at one end and a first ring at the other end, providing a second strap comprising a female connector at one end and a second ring at the other end, providing a third ring as a component of a bolt snap projecting at one end, and a plurality of strings, tying the strings to form nooses at each end, and securing the strings to the third ring, wherein the male connector is configured to connect to the female connector, and the bolt snap is configured to connect to the first and second ring.

In embodiments, the second strap may be provided to include a strap adjuster configured for adjusting the length of the strap. Further, the second strap may be longer than the first strap, and the male connector may be a quick release buckle.

In embodiments, the first strap may be manufactured through one or more or all of the steps comprising:

providing a first strip of material, the first ring, and the male quick release buckle, wherein the male quick release buckle has two slots dimensioned to accept the strip of material, and the first strip of material has a first end and a second end;

creating two arcuate bends in the strip of material, wherein the first arcuate bend is formed by the first end folded back onto the strip of material, and the second arcuate bend is formed by the second end formed folded back onto the strip of material over an edge of the ring;

attaching the strip of material together at the first end to form a first loop and at the distal end to form a second loop, wherein the length of the first loop exceeds the length of the second loop; wherein formation of the second loop secures the ring;

and threading the strip of material through the slots of the quick release buckle to form a third arcuate bend.

In embodiments, the second strap may be manufactured through one or more or all of the steps comprising:

providing a second strip of material, a female connector, a second ring, and a strap adjuster, wherein the female connector has a slot dimensioned to accept the strip of material, and second strip of material has a first end and a second end;

threading the first end of the second strip of material through the pair of slots on the strap adjuster so that it forms an arcuate bend at the adjuster, thereby folding back on itself;

attaching the first end of the second strip to the second strip to create a loop at the adjuster;

threading the second end of the second strip through the second ring;

threading the second end of the second strip of material through the adjuster again so that it doubles back on the loop at the adjuster; and

attaching the female buckle to the second end of the second strip by threading the second end of the second strip through the slot of the female buckle so that it forms an arcuate bend at the female buckle, thereby folding back on itself, and attaching the second end of the second strip to the second strip to create a loop that secures the female buckle.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 is a diagram showing two strips of materials that can be used in an embodiment of a method of manufacture and device of this disclosure.

FIG. 2 is a diagram showing a female latch, a male latch, a strap adjuster, and two rings that can be used in an embodiment of a method of manufacture and device of this disclosure.

FIG. 3 is a diagram showing step 1 of an embodiment of a method of manufacture of this disclosure.

FIG. 4 is a diagram showing step 2 of an embodiment of a method of manufacture of this disclosure.

FIG. 5 is a diagram showing step 3 of an embodiment of a method of manufacture of this disclosure.

FIG. 6 is a diagram showing step 4 of an embodiment of a method of manufacture of this disclosure.

FIG. 7 is a diagram showing a close up of step 4 of an embodiment of a method of manufacture of this disclosure.

FIG. 8 is a diagram showing step 5 of an embodiment of a method of manufacture of this disclosure which provides an embodiment of a completed small game carrier according to the invention.

FIG. 9 is a diagram showing step 5 of an embodiment of a method of manufacture of this disclosure which provides an embodiment of a completed small game carrier according to the invention.

FIG. 10 is a diagram of instructions for using a small game carrier of this disclosure.

FIG. 11 is a diagram showing usage of a small game carrier of this disclosure.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

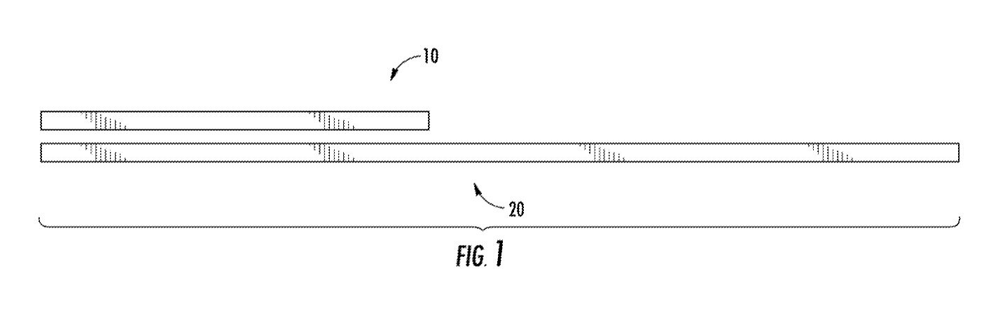

Turning now to the figures, FIG. 1 shows embodiments of a first 10 and second 20 elongated piece or strip of material that can be used in an embodiment of a device or method of manufacture of this disclosure. The first strip 10 of material may be approximately 50% or less, such as 45% or 40% of the length of the second strip 20 of material. In embodiments, one strip of material can be from 10-50%, or from 20-40%, or from 30-35% of the length of the other strip of material. For example, in one embodiment, the first strip 10 of material is about 22 inches in length and the second strip 20 of material is about 54 inches in length. As used herein, the term “about” or “approximately” preceding a value may include a range of values up to +/−10% of that value. Thus, a length of about 22 inches includes a length of 19.8 inches to a length of 24.2 inches. The width of the straps is approximately 1 inch and can range for example anywhere from about ¼ inch to 2 inches, such as ½ inch to 1.5 inches. The material may be a natural fabric such as cotton or hemp or a synthetic material such as polypropylene, polyester, or nylon, or a blend of any combination of natural and/or synthetic fabrics. The material may be provided in a variety of colors, including maroon, pink, olive green, hunter orange, black, dark brown, and tan.

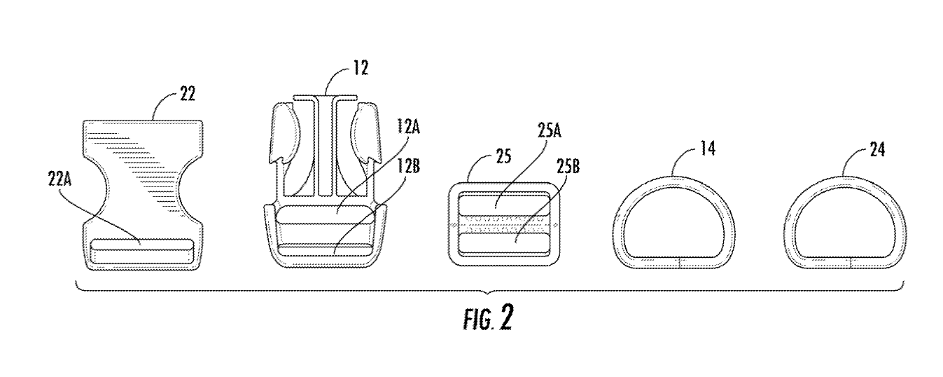

FIG. 2 shows an embodiment of additional components that can be used in a method of manufacture of this disclosure. These additional components include a female latch or quick release buckle 22, a male latch/quick release buckle 12, a strap adjuster 25, and two D-rings 14, 24. The female 22 and male latch 12 may be approximately 1 inch wide, and the male latch or quick release buckle may be slightly longer than the female latch or buckle (about 2 inches versus about 1.5 inches). The female latch 22 may have a slot 22A for accommodating the passage of the strap. The male quick release buckle 12 may have flexible tabs extending from the side to engage the female buckle as well as a pair of slots 12A and 12B to accommodate passage of the strap. The strap adjuster 25 may have a pair of slots 25A, 25B about an inch wide or otherwise appropriately sized to accommodate passage of the strap, and the D-rings 14, 24 may be slightly longer than about an inch long to accommodate passage of the strap and about 50% to 90% of the width.

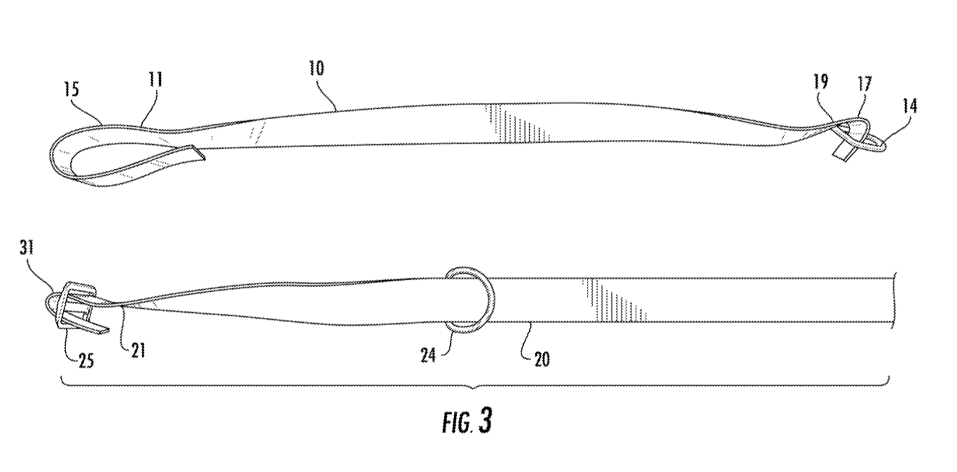

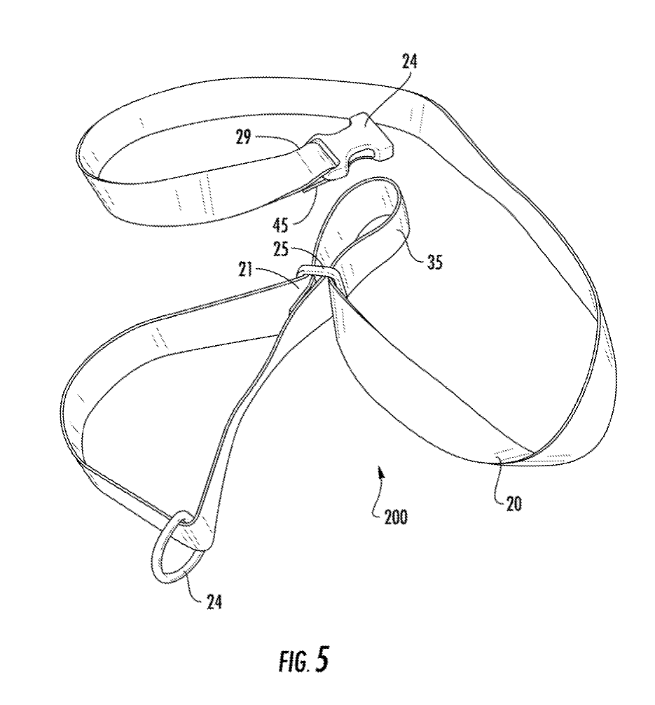

FIG. 3 shows step 1 of a method of manufacture of this disclosure. In step 1, the proximal 11 (left end in FIG. 3) and distal 19 (right end) of the first strip of material 10 are folded back on themselves to create a first arcuate bend 15 and a second arcuate bend 17 which form respective loops when the material is attached. When the material is folded down, the first loop is approximately 3 inches in length and the second loop is approximately 0.5 inches in length. One of the rings 14 is attached on the second loop of the first strip of material, and the material of both loops is sewn against the first strip of material at the ends of the material. For the second strip of material 20, the proximal end 21 is threaded through the pair of slots on the strap adjuster 25 so that it forms an arcuate bend 31 at the adjuster 25, thus folding back on itself, and the proximal end 21 of the strap is sewn against the strap to create a fixed loop 35 at a center post of the adjuster 25 (shown in FIG. 5). The distal end of the strap is threaded through the other ring 24 so that is positioned at approximately the middle of the strip 10.

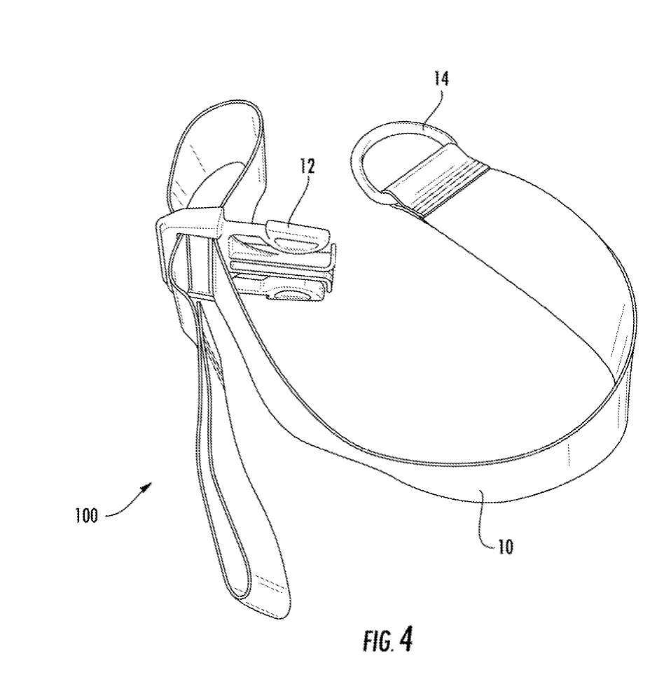

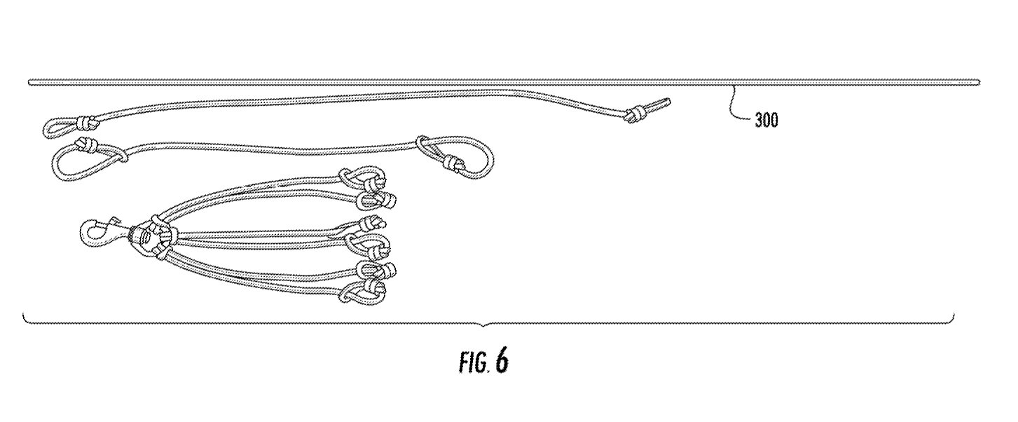

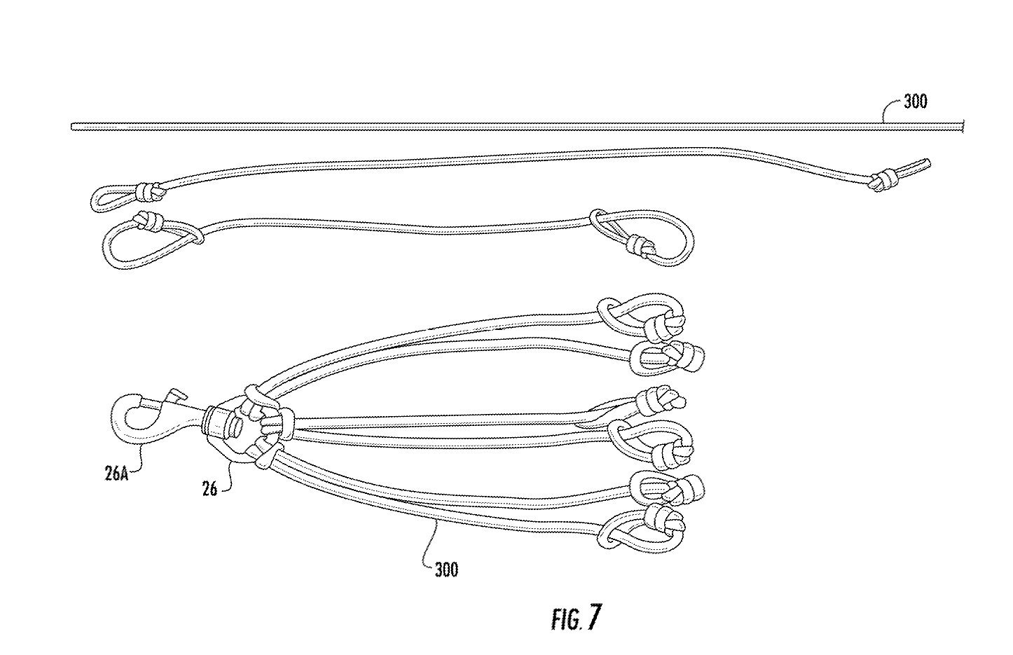

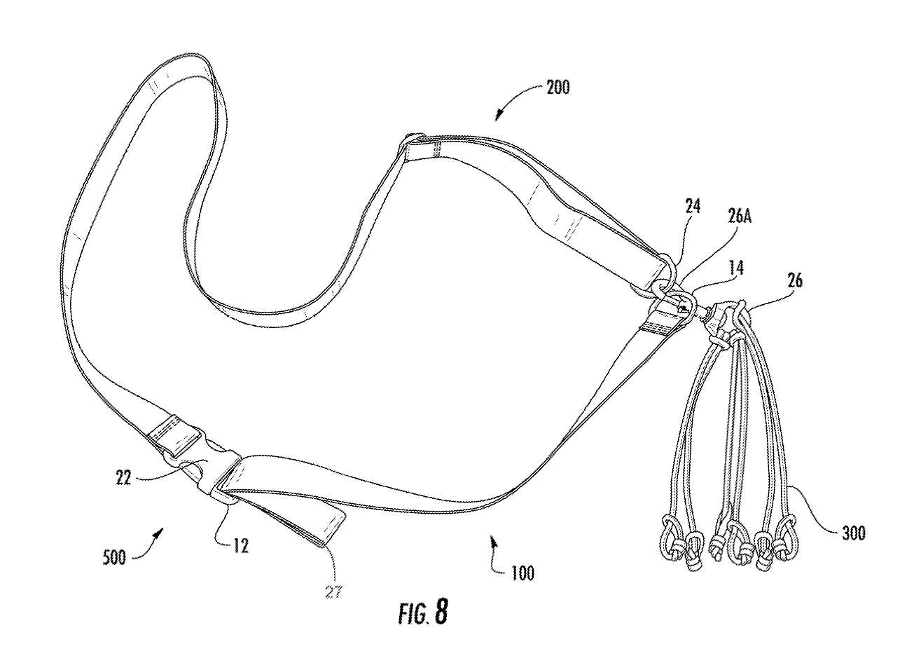

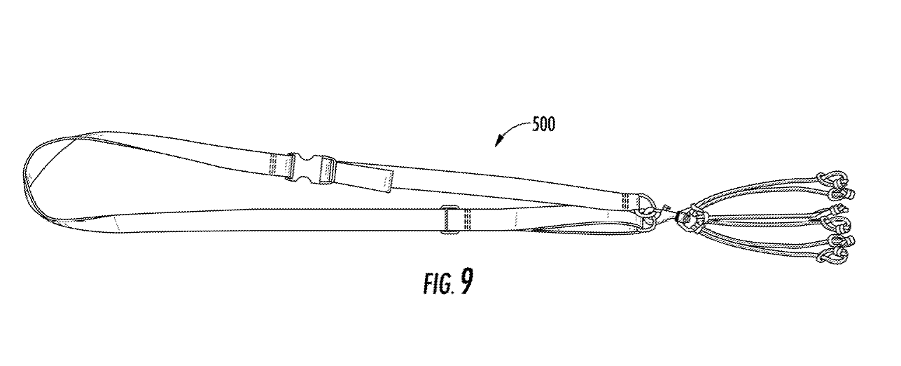

FIG. 4 shows step 2 of a method of manufacture of this disclosure. In step 2, the first strip 10 is threaded through the two slots of the male latch 12 so that it forms an arcuate bend. This step creates the first major strap 100 of the carrier. FIG. 5 shows that the second strip 20 is first threaded through the adjuster 25 again so that it doubles back on the loop. Then, the female buckle 22 is attached to the distal end 29 of the second strip by threading the strip 20 through the slot and bending it back on itself and sewing the distal end to the strip 20 to create a loop 45. This step creates the second major strap 200 of the carrier. FIGS. 6 and 7 show step 4, which creates the end of the carrier that holds small game animals. An elongated piece of string 300 is tied at the ends to create a loop at the end. The other end of the string is passed through the loop to create a large loop and the other end of the string is tied in a loop against the string to create a reciprocal loop. A plurality of strings 300 is similarly tied in such loop formations. The reciprocal loops serve as nooses to secure the neck of a duck or other small game animal. Each of the strings is secured to a ring by tying it in the middle. At the other end of the ring is a bolt snap 26A and ring 26 that is part of the bolt snap for securing it to the rings of the straps. FIGS. 8 and 9 show that assembly of the duck carrier 500 is completed by securing the male quick release buckle 12 of the first strap 100 to the female buckle 22 of the second strap 200 and securing the ring ends 14, 24 of the first and second strip to the bolt snap 26A with the small game nooses. The quick release buckle acts to join straps 100 and 200, and the male end of the quick release buckle 12 allows for the adjustment of the length of strap 100, which in turn adjusts the length of the combined strap 100, 200. This configuration provides for convenience during use of being able to adjust the strap 100 to a desired length without removal of the game carrier to fit a particular user or object by pulling on loop 27 (shown in FIG. 8) while the game carrier is worn or in use.

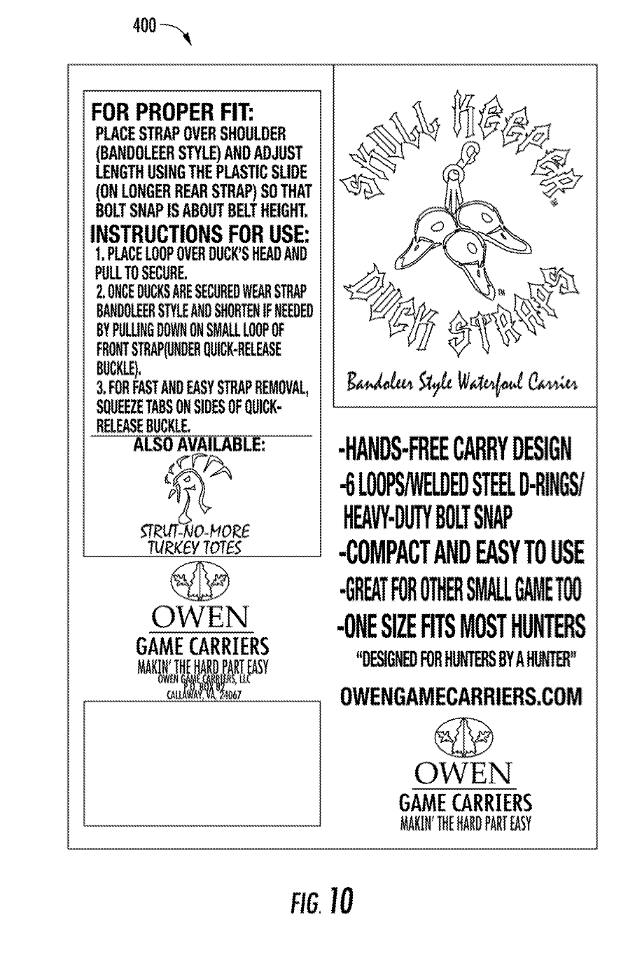

FIG. 10 shows a set of instructions 400 for using the game carrier. The instructions include placing the loop of the string over the duck (or other small game) head and pulling to secure. One or more game animals may be secured this way, depending on the number of strings tied to the ring—each string has two nooses at the end. The secured straps may be then worn Bandelier style by pulling down on the adjuster or the loop 27 (as shown in FIG. 8), and the straps released by squeezing tabs on the sides of the quick-release buckle to release the male and female connection and thus the connection between the first and second strips of material.

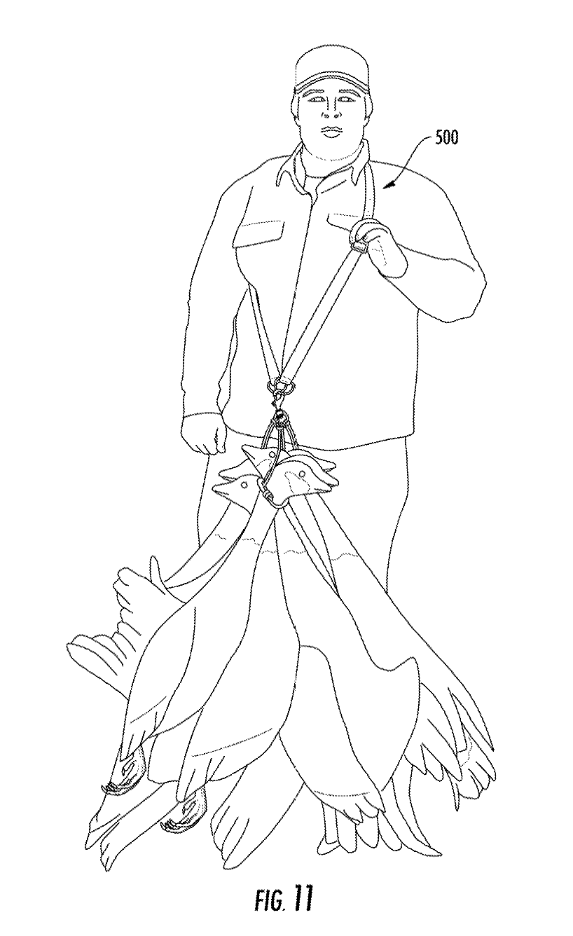

FIG. 11 shows the small game carrier 500 being used by a hunter. In this case, the small game carrier is being used to secure geese, but the small game nooses may be adapted to secure any small game, including other waterfowl such as ducks, grebes, coots, and herons, other game birds such as pheasants, doves and pigeons, and even small mammals such as rabbits and squirrels.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A method of manufacture of a small game carrier comprising:
providing a first strap, a male connector at one end of the first strap, and a first ring at an opposing end of the first strap;
providing a second strap, a female connector at one end of the second strap, and a second ring at an opposing end of the second strap;
providing a third ring as part of a bolt snap projecting at one end;
providing a plurality of strings;
tying each string to form a noose or loop at each end of each string; and
securing each string to the third ring;
wherein the male connector is configured to connect to the female connector, and the bolt snap is configured to connect to the first and second ring.

2. The method of claim 1, wherein the second strap is provided with a strap adjuster configured for adjusting a length of the second strap.

3. The method of claim 1, wherein the second strap is longer than the first strap.

4. The method of claim 1, wherein the male and female connectors together comprise a quick release buckle.

5. The method of claim 1, wherein the first strap is manufactured through the steps comprising:
providing a first strip of material, the first ring, and the male connector, wherein the male connector has two slots dimensioned to accept the first strip of material, and the first strip of material has a first end and a second end;
creating two arcuate bends in the strip of material, wherein the first arcuate bend is formed by the first end folded back onto the strip of material, and the second arcuate bend is formed by the second end formed folded back onto the strip of material over an edge of the first ring;
attaching the strip of material together at the first end to form a first loop and at the distal end to form a second loop, wherein the length of the first loop exceeds the length of the second loop; wherein formation of the second loop secures the first ring;
threading the strip of material through the slots of the quick release buckle to form a third arcuate bend.

6. The method of claim 1, wherein the second strap is manufactured through the steps comprising:
providing a second strip of material, the female connector, the second ring, and the strap adjuster, wherein the female connector has a slot dimensioned to accept the second strip of material, and the second strip of material has a first end and a second end;
threading the first end of the second strip of material through the pair of slots on the strap adjuster so that it forms an arcuate bend at the adjuster, thereby folding back on itself;
attaching the first end of the second strip of material to the second strip of material to create a fixed loop around a center post of the adjuster;
threading the second end of the second strip through the second ring;
threading the second end of the second strip of material through the adjuster again so that it doubles back on the loop at the adjuster; and
attaching the female connector to the second end of the second strip by threading the second end of the second strip through the slot of the female connector so that it forms an arcuate bend at the female connector, thereby folding back on itself, and attaching the second end of the second strip to the second strip to create a loop that secures the female connector.

7. The method of claim 1, further comprising connecting the male connector to the female connector.

8. The method of claim 1, further comprising connecting the bolt snap to the first and second ring.

9. The method of claim 1, wherein the first ring and second ring are D-rings.

10. A small game carrier, comprising:
a first strap comprising a male connector at one end and a first ring at an opposing end of the first strap;
a second strap comprising a female connector at one end and a second ring at an opposing end of the second strap with a strap adjuster in between;
a third ring as part of a bolt snap latch projecting at one end;
a plurality of strings with each end tied to form a noose, wherein the strings are secured to the third ring;
wherein the male connector is configured to connect to the female connector, and the bolt snap latch is configured to connect to the first and second ring.

11. The small game carrier of claim 10, wherein the second strap is longer than the first strap.

12. The small game carrier of claim 10, wherein the male connector and the female connector together comprise a quick release buckle.

13. The small game carrier of claim 12, wherein the male connector is connected to the female connector.

14. The small game carrier of claim 10, wherein the bolt snap latch is connected to the first and second ring.

15. The small game carrier of claim 1, wherein both the first strap and the second strap are adjustable in length.
